(19) United States
(12) Patent Application Publication
(10) Pub. No.: US 2021/0394470 A1
(43) Pub. Date: Dec. 23, 2021

(54) OPTICAL ELEMENT MODULE FABRICATION

(71) Applicant: ams Sensors Singapore Pte. Ltd., Singapore (SG)

(72) Inventor: Uros Markovic, Zurich (CH)

(21) Appl. No.: 17/288,735

(22) PCT Filed: Nov. 1, 2019
(86) PCT No.: PCT/SG2019/050535

§ 371 Date: Apr. 26, 2021

Related U.S. Application Data
(60) Provisional application No. 62/754,782, filed on Nov. 2, 2018.
(60) Provisional application No. 62/837,298, filed on Apr. 23, 2019.

(51) Int. Cl. B29D 11/00; G02B 3/00

(52) U.S. Cl. CPC B29D 11/00307; G02B 3/0031; B29D 11/00298

(57) ABSTRACT

A method includes: providing a substrate, in which a first surface of the substrate includes at least one optical element module region defining an area in which multiple optical elements are to be disposed; forming, for each optical element module region on the first surface of the substrate, a corresponding reflow waste channel in the first surface of the substrate and around a perimeter of the optical element module region; providing a first optical element mold, in which a surface of the first optical element mold includes multiple first cavities, each first cavity defining a shape of a corresponding optical element of the multiple optical elements; providing resin globules between the surface of the optical element mold and the first surface of the substrate; and compressing the first optical element mold to the first surface of the substrate so that the resin fills the multiple first cavities, and so that excess resin flows into the reflow waste channel.

### TECHNICAL FIELD

The present disclosure relates to fabrication of optical element modules.

### BACKGROUND Batch fabrication technologies for optical elements may include forming the multiple optical elements on surfaces of semiconductor or dielectric substrates.

### SUMMARY

In general, in some aspects, the subject matter of the present disclosure may be embodied in methods for manufacturing an optical element module, in which the methods include: providing a substrate, in which a first surface of the substrate includes at least one optical element module region defining an area in which multiple optical elements are to be disposed; forming, for each optical element module region on the first surface of the substrate, a corresponding reflow waste channel in the first surface of the substrate and around a perimeter of the optical element module region; providing a first optical element mold, in which a surface of the first optical element mold includes multiple first cavities, each first cavity defining a shape of a corresponding optical element of the multiple optical elements; providing a first multiple of globules of a curable resin between the surface of the optical element mold and the first surface of the substrate; and compressing the first optical element mold to the first surface of the substrate so that the first multiple of globules fill the multiple first cavities, and so that excess curable resin flows into the reflow waste channel around the perimeter of each optical element module region.

Implementations of the methods may include one or more of the following features. For example, in some implementations, for a first optical element module region, forming the corresponding reflow waste channel includes dicing a groove into the first surface of the substrate. A width of the groove may be defined by a distance between facing walls of the groove, and the width of the groove may be between approximately 100 microns and approximately 1 mm. In some implementations, the methods include curing the first multiple of globules to form the multiple optical elements, and separating the substrate including the multiple optical elements into at least one separate optical element module, in which dicing the groove into the first surface of the substrate includes applying a first dicing blade having a first diameter to the first surface of the substrate, and in which separating the substrate into at least one optical element module includes dicing the substrate with a second dicing blade having a second diameter that is larger than the first diameter.

In some implementations, for a first optical element module region, forming the corresponding reflow waste channel includes forming a groove into the first surface of the substrate, in which at least one wall of the groove is beveled.

In some implementations, for a first optical element module region of the substrate, the corresponding reflow waste channel extends continuously around the first optical element module region.

In some implementations, for a first optical element module region of the substrate, the corresponding reflow waste channel includes multiple separate sub-channels that extend around the first optical element module region.

In some implementations, for a first optical element module region of the substrate, the corresponding reflow waste channel entirely surrounds the perimeter of the first optical element module region.

In some implementations, the first surface of the substrate includes multiple optical element module regions, and, for each optical element module region of the multiple optical element module regions, the corresponding reflow waste channel surrounding the perimeter of the optical element module region intersects with a reflow waste channel of an adjacent optical element module region.

In some implementations, further including: curing the first multiple of globules to form the multiple of optical elements; and separating the substrate including the multiple of optical elements into one or more separate optical element modules. Separating the substrate may include dicing the substrate. Dicing the substrate may include dicing along the reflow waste channels.

In some implementations, gas bubbles are forced into and trapped in at least one reflow waste channel as a result of compressing the first optical element mold to the first surface of the substrate.

In some implementations, providing the first multiple of globules of the curable resin includes providing the first multiple of globules on the surface of the first optical element mold that includes the multiple first cavities.

In some implementations, a second surface of the substrate includes at least one additional optical element module region; and the method further includes forming, for each additional optical element module region on the second surface of the substrate, a corresponding reflow waste channel in the second surface of the substrate and around a perimeter of the additional optical element module region; providing a second optical element mold, in which a surface of the second optical element mold includes multiple second cavities, each second cavity of the second optical element mold defining a shape of a corresponding optical element; providing a second multiple of globules of a curable resin between the surface of the second optical element mold and the second surface of the substrate; compressing the second optical element mold to the second surface of the substrate so that the second multiple of globules fill the multiple second cavities, and so that excess curable resin flows into the reflow waste channel around the perimeter of each additional optical element module region. For a first additional optical element module region of the substrate, the corresponding reflow waste channel may extend continuously around the first additional optical element module region. For a first additional optical element module region of the substrate, the corresponding reflow waste channel may include multiple separate sub-channels that extend around the first optical element region. For a first additional optical element module region of the substrate, the corresponding reflow waste channel may entirely surround the perimeter of the first additional optical element module region. The second surface of the substrate may include multiple additional optical element module regions, in which, for each additional optical element module region of the multiple additional optical element module regions, the corresponding reflow waste channel surrounding the perimeter of the additional optical element module region intersects with a reflow waste channel of an adjacent additional optical element module region. Gas bubbles may be forced into and trapped in at least one reflow waste channel in the second surface of the substrate as a result of compressing the second optical element mold to the second surface of the substrate.

In some implementations, the multiple optical elements include a refractive optical element, a diffractive optical element, a diffusive optical element, or a combination thereof.

Implementations of the presently disclosed subject matter may have one or more advantages. For example, in some implementations, the use of the reflow waste channels allows gas bubbles that would otherwise be trapped in the optical elements to be captured in regions that ultimately do not form part of the optical elements or part of the optical element modules. By reducing the gas bubbles that end up in the optical elements, the quality and throughput of the optical element modules can be improved. In some implementations, the use of a dicing blade for the second separation cut that has a smaller blade thickness than a blade thickness of the dicing blade used to form the reflow waste channels can reduce the amount of time that cured resin is exposed to a blade during dicing. In some cases, the smaller blade thickness can also reduce chipping of the cured resin, which can improve the quality and thus throughput of the optical element modules.

The details of one or more embodiments are set forth in the accompanying drawings and the description below. Other features and advantages will be apparent from the description, drawings, and claims.

### DESCRIPTION OF DRAWINGS

FIG. 1 is a schematic that illustrates an example of an optical element module.

FIG. 2 is a schematic that illustrates an exploded view of the optical element module of FIG. 1.

FIGS. 3A-3M are schematics that depict an exemplary optical module fabrication process.

### DETAILED DESCRIPTION

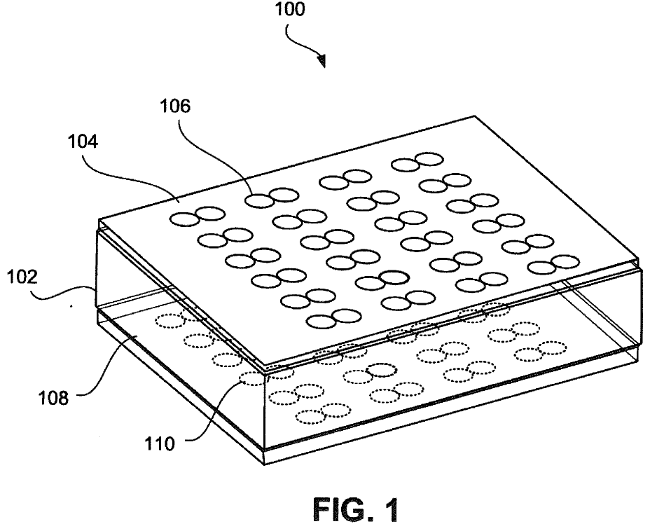

The present disclosure relates to optical element module fabrication. FIG. 1 is a schematic that illustrates an example of an optical element module 100. Module 100 includes a substrate 102 having a first surface 104 and a second surface 108 that is opposite to the first surface 104. In some implementations, module 100 includes one or more optical elements 106 formed on the first surface 104. In some implementations, module 100 also includes one or more optical elements 110 on the second surface 108 of the substrate 102.

The optical elements 106, 110 are structures that perform an optical function, such as refraction, reflection, diffusion, and/or diffraction of light. Optical elements 106, 110 can include, but are not limited to, elements such as lenses, mirrors, diffraction gratings, or prisms. Optical elements 106, 110 can be arranged randomly or in ordered arrays such as shown in FIG. 1. In some implementations, the surfaces on which the optical elements 106, 110 are formed (e.g., first surface 104 and second surface 108) include additional features or structures. For example, in some cases, the surfaces 104, 108 beneath the optical elements 106, 110 include light detector elements (e.g., CCD elements) for detecting light that passes through the optical elements 106, 100. Alternatively, or in addition, the surfaces 104, 108 include, but are not limited to, structures such as diffracting gratings, mirrors or apertures. For example, the surfaces 104, 108 may include apertures formed from thin-film layers of chrome.

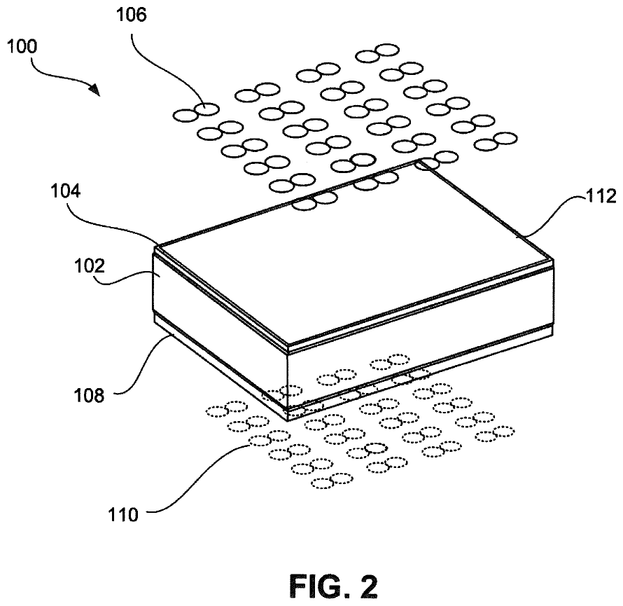

FIG. 2 is a schematic that illustrates an exploded view of the optical element module 100. In addition to optical elements 106, 110, the exploded view depicts an additional layer 112 formed on first surface 104 of substrate 102. This additional layer 112 may include one or more of the features, e.g., light detector elements, diffraction elements, or apertures, as described herein. As shown in FIG. 2, layer 112 includes a metal thin film, such as chrome.

Substrate 102 is provided for supporting layer 112, optical elements 106 and optical elements 110. Substrate 102 may include semiconductor material such as, e.g., silicon. Alternatively, or in addition, substrate 102 may be formed from dielectric material such as, e.g., glass or polymers including polyimides. The substrate 102 include, e.g., 6-8 inch diameter wafers, in the case of round wafers. Alternatively, the substrate 102 can include square wafers having, e.g., 6-8 inches a side. The substrate thickness may be between, e.g., 300 μm to 3 mm, generally.

In some implementations, fabrication of optical elements, such as elements 104 and 110, of an optical element module entails forming the optical elements using molds.

For instance, a curable material, such as an epoxy or other polymer, is provided in liquid form between a surface of the substrate 102 and a mold. The mold defines a shape of the optical element to be formed. While held in place by the mold, the curable material is cured so it solidifies into the optical element. Following the cure step, the substrate on which the optical elements are formed may be diced into multiple chips, each chip containing an array of optical elements. In certain cases, however, gas bubbles become trapped in the curable material as they have no means of escaping during the fabrication process. These trapped gas bubbles remain within the curable material once it is solidified leading to poorly performing optical elements and low yield. For instance, trapped gas bubbles within a lens can lead to deformation of the lens curvature and/or variation in the designed lens refractive index. In some cases, if even one optical element is found to be defective due to trapped gas bubbles, then it may be necessary to dispose of an entire chip even if the remaining optical elements are without defects.

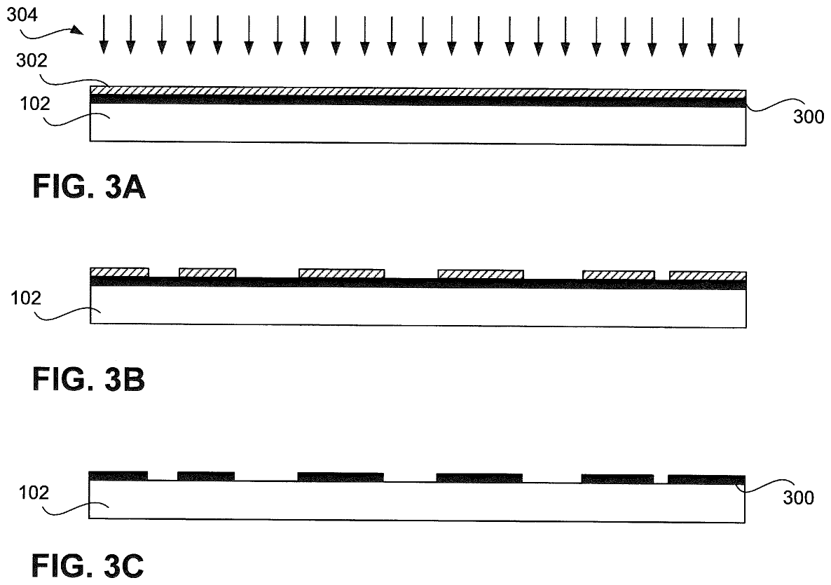

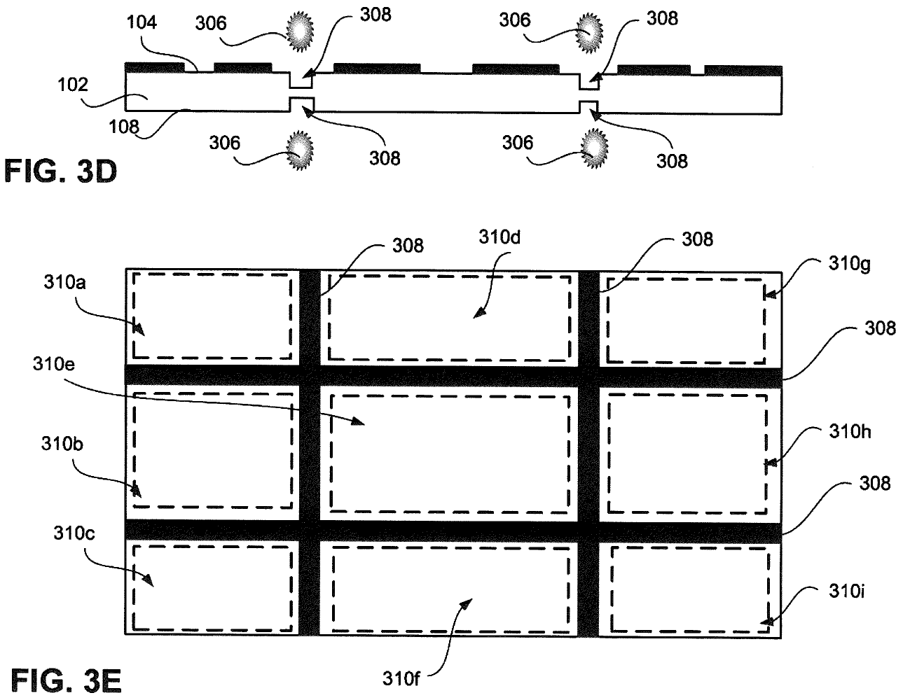

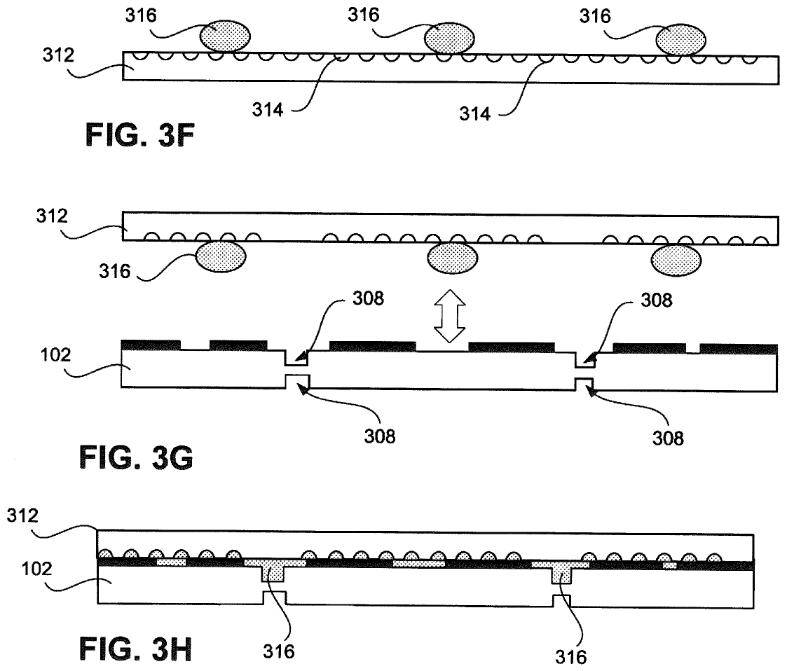

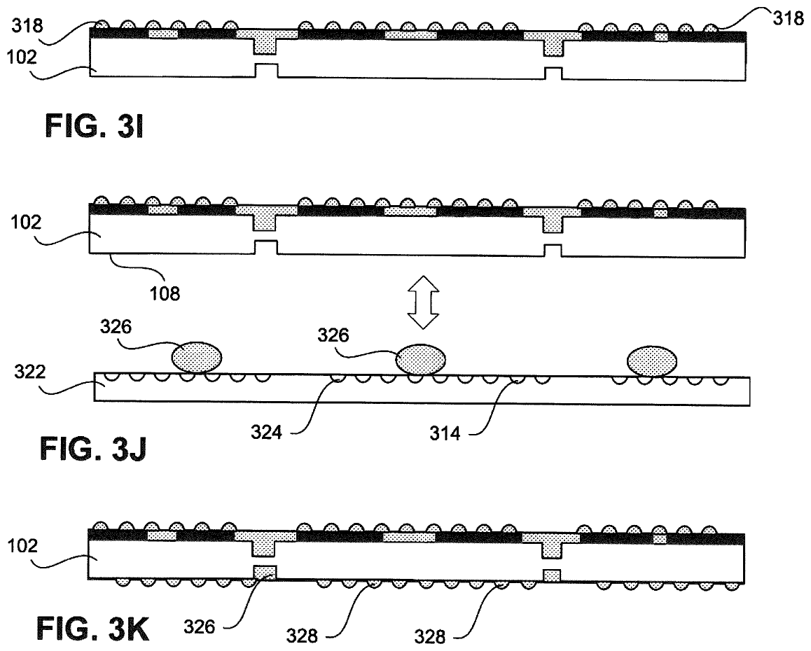

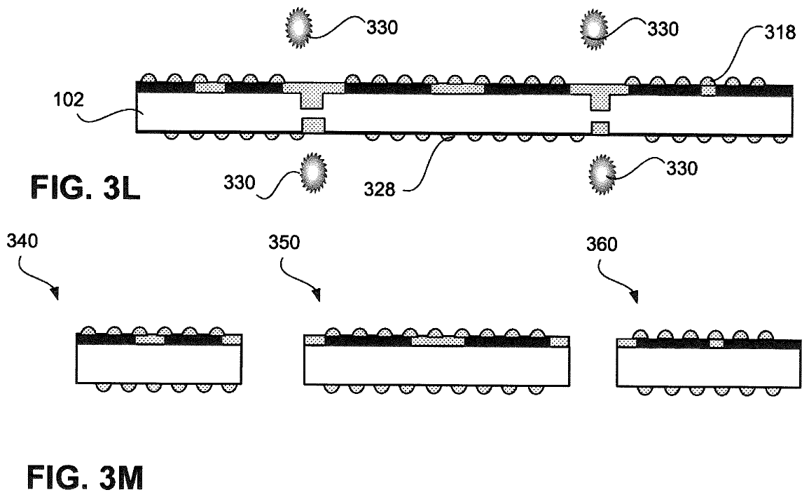

FIGS. 3A-3M are schematics that depict an exemplary optical module fabrication process that reduces trapping of gas bubbles in optical element formation and can lead to improved device yield. In particular, the fabrication process disclosed herein introduces channels or grooves within the substrate on which the optical elements are formed. During the molding process, gas bubbles propagate toward the channels and away from the regions where the optical elements are formed. The gas bubbles remain in the channels during the curing step, thus preventing the trapped gas from adversely affecting the formation of the optical elements. In some cases, the channels into which the gas bubbles end up also serve as markers for identifying where a substrate is to be diced. In other words, the channels may define the perimeter of at least one chip to be formed from the substrate.

As shown in FIG. 3A, a substrate 102 is provided. The substrate 102 may include a semiconductor wafer, such as silicon, or may be formed from another material including dielectrics such as glass. For example, substrate 302 may include a borosilicate glass plate that is 8 inches by 8 inches and 2.4 mm thick. The substrate 102 may optionally include one or more layers on its surface. For example, as shown in FIG. 3A, substrate 102 includes a layer 300 on a top surface. Layer 300 may include, e.g., a thin-film of metal, dielectric or semiconductor. In some cases, the layer (or layers) on the surface of the substrate 102 are processed to have a predefined pattern. Such processing may entail, e.g., a photolithography step to define the regions of layer 300 to be modified. For instance, in some cases, a layer of photoresist 302 is formed on top of the layer 300. Light 304 from a photolithography exposure system may be directed through a mask to the photoresist layer 302 to selectively expose portions of the layer 302 and cause a molecular change in the exposed material, rendering the exposed material either soluble or insoluble in a developer solution. Following exposure, the soluble portions of the photoresist layer 302 then are removed in the developer solution leaving the desired pattern as shown in FIG. 3B, where portions of the underlying layer 300 are exposed.

Then, as shown in FIG. 3C, the exposed portions of the layer 300 may be removed. Such removal may include applying a wet chemical etchant or dry etchant to the exposed portions of layer 300. On the other hand, portions of layer 300 covered by the resist are protected from removal and remain on the substrate surface. Following removal of desired portions of the layer 300, the remaining photoresist material may also be removed. Though the patterning of layer 300 shown in FIGS. 3A-3C are performed using what is referred to as an lithography then etch process, the same pattern in layer 300 may also be formed using what is referred to as a lift-off process, in which the photoresist layer is formed beneath layer 300. In the lift-off process, the undesired portions of layer 300 are removed along with the soluble part of the underlying photoresist.

In some implementations, multiple layers may be formed and patterned on the surface of substrate 102. The layer or layers 300 on substrate 102 may ultimately be arranged to provide functional elements on the substrate surface. For instance, in some cases, the one or more layers, may be configured to form optical elements such as mirrors or diffracting gratings. In some cases, the one or more layers, together with the substrate may form functional elements. For instance, the substrate 102 together with the patterned layer 302 may provide optical detector elements, such as charge-coupled detectors (CCDs). Other functional elements are also possible.

After providing the substrate 102 (with or without additional layers on its surface), at least one reflow waste channel 308 is formed in the substrate surface, as shown in FIG. 3D. The reflow waste channels 308 are grooves or trenches formed in the surface of the substrate 102. The reflow waste channels 308 may be formed, e.g., using a dicing blade 306.

The width of each flow waste channel 308 may be set according to the width of the dicing blade 306 used. For example, the reflow waste channels 308 may have widths in the range of about 50 microns to about 1 mm including, e.g., widths of about 100 microns, about 200 microns, about 300 microns, about 400 microns, about 500 microns, about 600 microns, about 700 microns, about 800 microns, or about 900 microns. The reflow waste channels 308 extend only partially into the substrate 102. For example, the reflow waste channels 308 may have depths in the range of about 50 microns to about 1 mm, including, e.g., depths of about 100 microns, about 200 microns, about 300 microns, about 400 microns, about 500 microns, about 600 microns, about 700 microns, about 800 microns, or about 900 microns. The ratio of width to depth of the reflow waste channels 308 may be in the range of about 1:10 to about 10:1 including, e.g. ratios of about 1:5, about 1:4, about 1:3, about 1:2, about 1:1, about 2:1, about 3:1, about 4:1, or about 5:1. A depth and width of the channels 308 may be designed based on the intended size and arrangement of the optical elements to be formed on the substrate, as well as the expected tolerances for epoxy overflow from the optical element module regions.

As shown in FIG. 3D, reflow waste channels 308 may be formed on multiple surfaces of the substrate 102. For example, the reflow waste channels 308 may be formed on a first surface 104 (e.g., the top surface) of the substrate and on a second surface 108 (e.g., the bottom surface) that is opposite to the first surface 104. In some implementations, the reflow waste channels 308 are formed on only one surface of the substrate 102.

The surfaces of the substrate 102 may include one or more optical element module regions that define an area in which multiple optical elements are to be disposed. In some implementations, the reflow waste channels 308 are formed around a perimeter of one or more of the optical element module regions. By forming the reflow waste channels 308 around the optical module regions, the channels 308 are arranged to receive gas bubbles forced out along different directions from the optical element module regions.

FIG. 3E is a schematic that depicts a top surface, such as surface 104, of substrate 102. As shown in FIG. 3E, the top surface 104 includes multiple optical element module regions 310a-310i identified by the dashed lines. It should be noted that the dashed lines are not actually present on the surface 104 but are provided here for ease of identifying the optical element module regions. Although the module regions 310 are shown to have a rectangular area, the regions 310 may have a size and shape that is based on the desired size and arrangement of the optical elements to be included in the regions 310.

At least optical element module region 310e shown in FIG. 3E is entirely surrounded by reflow waste channels 308. In the present example, the channels 308 that surround optical element module region 310e are formed continuously, without break, around the optical element module region 310e. In some implementations, however, the channels 308 that surround an optical element module region are formed in a non-continuous manner. For instance, the channels 308 may include one or more breaks where a groove is not formed in the surface of the substrate 102, resulting in multiple sub-channels that extend around the optical element module region.

Although only a single optical element module region 310e is shown as being entirely surrounded by the channels 308, the channels 308 may surround other optical element module regions 310 as well. In some implementations, the channels 308 that are formed around a first optical element module region intersect with and/or double as a channel 308 that is formed around a second optical element module region. For example, as shown in FIG. 3E, the channels 308 surrounding region 310e intersect with the channels 308 arranged around a perimeter of adjacent regions 310a, 310b, 310c, 310d, 310f, 310g, 310h, and 310i. Additionally, the channels 308 formed around the perimeter of region 310e also double as the channels 308 that are arranged around at least part of the perimeter of the adjacent regions 310b, 310d, 310f, and 310h. In some implementations, the channels 308 formed around a perimeter of a first optical element module region do not double as channels 308 for adjacent optical element module regions. For example, in some cases, each optical element module region 310 is surrounded by a dedicated group of reflow waste channels 308.

The reflow waste channels 308 shown in FIG. 3D have rectangular cross-sections as a result of the dicing blades used to form the channels 308. However, the cross-section of the reflow waste channel 308 can have other shapes instead depending on the fabrication technique used to form the channel 308. For instance, in some cases, the channel 308 can be formed using an isotropic chemical etch, resulting in a generally semi-circular cross-section. In some cases, the channel 308 can be formed using a gas-based dry etch, in which the directional flow of etchants is oblique with respect to the substrate surface, resulting in an inclined trench bottom in the channel 308. Alternatively, or in addition, the etching process may result in at least one wall of the channel 308 having a beveled surface.

After forming the channels 308 in the surface or surfaces of the substrate 102, at least one optical element mold 312 is provided as shown in FIG. 3F. A surface of the optical element mold 312 include multiple first cavities 314, in which each first cavity defines a shape of a corresponding optical element to be formed on the substrate 102. The cavities 314 may define, e.g., a lens, a prism, a diffraction grating, or other optical element.

One or more globules 316 of a curable resin may then be provided between the surface of the optical element mold 314 and the first surface 104 of the substrate, as shown in FIGS. 3F-3G. The curable resin may include, e.g., a polymer that can be cured and solidified upon exposure to heat, radiation, electron beams, or through chemical additives. The curing process may be used to cause polymers within the resin to cross-link, thus hardening the state of the polymer. Examples of curable resins include epoxy resins. Once cured, the resin may be transparent or translucent to a desired wavelength or range of wavelengths of light.

As shown in FIG. 3F, the globules 316 are provided on the mold 312 first and the mold 312 then is applied to the surface of the substrate 102 as shown in FIG. 3G. In alternative implementations, the globules 316 may be provided to the surface of the substrate 102 first. Alternatively, the globules 316 may be provided to both the surface of the mold 312 and the surface of the substrate 102.

After the globules 316 have been provided, the mold 312 is compressed to the surface of the substrate 102 as shown in FIGS. 3G-3H. As a result of the compression applied, the resin fills the cavities 314 of the mold. Additionally, excess resin 316 is pushed out from the optical element module regions into the surrounding channels 308 as shown in FIG. 3H. Additionally, gas bubbles within the curable resin are forced into and trapped in at least one reflow waste channel as a result of compressing the first optical element mold to the first surface of the substrate. In some implementations, a thin layer of resin remains underneath the optical elements that are defined by the compression process. For example, the thin layer of resin may have a thickness between about 10 microns to about 60 microns. In some implementations, the mold 312 does not include spacers that extend outwardly from its surface so that the surface of the mold 312 can be placed flat against the resin-coated substrate. Using molds 312 without spacers may increase the mold lifetime and make the mold easier to reproduce. After compressing the mold 312 to the substrate 102, the resin then is cured to form the multiple optical elements 318 and the mold 312 may be removed, as shown in the example of FIG. 31.

In some implementations, multiple optical elements are also formed on a reverse or second side of the substrate 102. For example, as shown in FIGS. 3J-3K, a second mold 322 is provided. Additional globules 326 of resin then are provided between the surface of the optical element mold 322 and the second surface 108 of the substrate. As explained herein, the curable resin may include, e.g., a polymer that can be cured and solidified upon exposure to heat, radiation, electron beams, or through chemical additives. The curing process may be used to cause polymers within the resin to cross-link, thus hardening the state of the polymer. Examples of curable resins include epoxy resins. Once cured, the resin may be transparent or translucent to a desired wavelength or range of wavelengths of light.

A surface of the optical element mold 322 include multiple second cavities 324, in which each second cavity 324 defines a shape of a corresponding optical element to be formed on the second surface 108 of the substrate 102. The cavities 324 may define, e.g., a lens, a prism, a diffraction grating, or other optical element.

After the globules 326 have been provided, the mold 322 is compressed to the second surface 108 of the substrate 102 as shown in FIGS. 3J-3K. As a result of the compression applied, the resin fills the cavities 324 of the mold. Additionally, excess resin 326 is pushed out from the optical element module regions into the surrounding channels 308 as shown in FIG. 3K. Additionally, gas bubbles within the curable resin are forced into and trapped in at least one reflow waste channel as a result of compressing the first optical element mold to the first surface of the substrate. In some implementations, a thin layer of resin remains underneath the optical elements that are defined by the compression process. For example, the thin layer of resin may have a thickness between about 10 microns to about 60 microns. After compressing the mold 322 to the substrate 102, the resin then is cured to form the multiple optical elements 328 and the mold 322 may be removed, as shown in the example of FIG. 3K.

After the optical elements have been formed on one or both sides of the substrate 102, the substrate 102 including the optical elements may be separated into one or more separate optical element modules, as shown in FIGS. 3L-3M. For instance, the substrate 102 can be separated into multiple separate optical element modules by dicing the substrate. Dicing can be performed, e.g., using dicing blades 330. In some implementations, the substrate is separated along the reflow waste channels 308. For example, the dicing blades 330 may dice through the substrate using the waste channels 308 as guides for where the substrate is to be cut. Each optical element module region may then result in a corresponding separate chip after separation. For example, as shown in FIG. 3M, multiple separate optical element modules 340, 350, and 360 may be formed.

The width of the cut made on the first and/or second sides of the substrate 102 may be set according to the thickness of the dicing blade 330 used. In some implementations, the width of the deep cut through substrate 102 (otherwise referred to as the chip separation cut) shown in FIG. 3L is less than a width of the first shallow cut performed to obtain the reflow waste channels 308 (the reflow waste channel cut). As an example, the width of the separation cuts may be in the range of about 50 microns to about 1 mm including, e.g., widths of about 100 microns, about 200 microns, about 300 microns, about 400 microns, about 500 microns, about 600 microns, about 700 microns, about 800 microns, or about 900 microns.

A number of embodiments have been described. Nevertheless, it will be understood that various modifications may be made without departing from the spirit and scope of the invention. Accordingly, other embodiments are within the scope of the following claims.

1. A method for manufacturing an optical element module, the method comprising:
providing a substrate, wherein a first surface of the substrate comprises at least one optical element module region defining an area in which a plurality of optical elements are to be disposed;
forming, for each optical element module region on the first surface of the substrate, a corresponding reflow waste channel in the first surface of the substrate and around a perimeter of the optical element module region;
providing a first optical element mold, wherein a surface of the first optical element mold comprises a plurality of first cavities, each first cavity defining a shape of a corresponding optical element of the plurality of optical elements;
providing a first plurality of globules of a curable resin between the surface of the optical element mold and the first surface of the substrate; and
compressing the first optical element mold to the first surface of the substrate so that the first plurality of globules fill the plurality of first cavities, and so that excess curable resin flows into the reflow waste channel around the perimeter of each optical element module region.

2. The method of claim 1, wherein, for a first optical element module region, forming the corresponding reflow waste channel comprises dicing a groove into the first surface of the substrate.

3. The method of claim 2, wherein a width of the groove is defined by a distance between facing walls of the groove, and wherein the width of the groove is between approximately 100 microns and approximately 1 mm.

4. The method of claim 1, wherein, for a first optical element module region, forming the corresponding reflow waste channel comprises forming a groove into the first surface of the substrate, wherein at least one wall of the groove is beveled.

5. The method of claim 1, wherein for a first optical element module region of the substrate, the corresponding reflow waste channel extends continuously around the first optical element module region; and/or wherein for a first optical element module region of the substrate, the corresponding reflow waste channel entirely surrounds the perimeter of the first optical element module region.

6. The method of claim 1, wherein for a first optical element module region of the substrate, the corresponding reflow waste channel comprises a plurality of separate sub-channels that extend around the first optical element module region.

7. (canceled)

8. The method of claim 1, wherein the first surface of the substrate comprises a plurality of optical element module regions, and wherein, for each optical element module region of the plurality of optical element module regions, the corresponding reflow waste channel surrounding the perimeter of the optical element module region intersects with a reflow waste channel of an adjacent optical element module region.

9. The method of claim 1, further comprising:
curing the first plurality of globules to form the plurality of optical elements; and
separating the substrate comprising the plurality of optical elements into one or more separate optical element modules.

10. The method of claim 9, wherein separating the substrate comprises dicing the substrate.

11. The method of claim 10, wherein dicing the substrate comprises dicing along the reflow waste channels.

12. The method of claim 1, wherein gas bubbles are forced into and trapped in at least one reflow waste channel as a result of compressing the first optical element mold to the first surface of the substrate.

13. The method of claim 1, wherein providing the first plurality of globules of the curable resin comprises providing the first plurality of globules on the surface of the first optical element mold that comprises the plurality of first cavities.

14. The method of claim 1, wherein a second surface of the substrate comprises at least one additional optical element module region;
forming, for each additional optical element module region on the second surface of the substrate, a corresponding reflow waste channel in the second surface of the substrate and around a perimeter of the additional optical element module region;
providing a second optical element mold, wherein a surface of the second optical element mold comprises a plurality of second cavities, each second cavity of the second optical element mold defining a shape of a corresponding optical element;
providing a second plurality of globules of a curable resin between the surface of the second optical element mold and the second surface of the substrate;
compressing the second optical element mold to the second surface of the substrate so that the second plurality of globules fill the plurality of second cavities, and so that excess curable resin flows into the reflow waste channel around the perimeter of each additional optical element module region.

15. The method of claim 14, wherein for a first additional optical element module region of the substrate, the corresponding reflow waste channel extends continuously around the first additional optical element module region.

16. The method of claim 14, wherein for a first additional optical element module region of the substrate, the corresponding reflow waste channel comprises a plurality of separate sub-channels that extend around the first optical element region.

17. The method of claim 14, wherein for a first additional optical element module region of the substrate, the corresponding reflow waste channel entirely surrounds the perimeter of the first additional optical element module region.

18. The method of claim 14, wherein the second surface of the substrate comprises a plurality of additional optical element module regions, and wherein, for each additional optical element module region of the plurality of additional optical element module regions, the corresponding reflow waste channel surrounding the perimeter of the additional optical element module region intersects with a reflow waste channel of an adjacent additional optical element module region.

19. The method of claim 14, wherein gas bubbles are forced into and trapped in at least one reflow waste channel in the second surface of the substrate as a result of compressing the second optical element mold to the second surface of the substrate.

20. The method of claim 1, wherein the plurality of optical elements comprises a refractive optical element, a diffractive optical element, a diffusive optical element, or a combination thereof.

21. The method of claim 2, comprising:
curing the first plurality of globules to form the plurality of optical elements; and
separating the substrate comprising the plurality of optical elements into at least one separate optical element module,
wherein dicing the groove into the first surface of the substrate comprises applying a first dicing blade having a first blade thickness to the first surface of the substrate, and
wherein separating the substrate into at least one optical element module comprises dicing the substrate with a second dicing blade having a second blade thickness that is larger than the first blade thickness.
